(19) United States
(12) Patent Application Publication
(10) Pub. No.: US 2011/0115695 A1
(43) Pub. Date: May 19, 2011

(54) OPTICAL SHEET AND RELEVANT BACKLIGHT MODULE AND LIQUID CRYSTAL DISPLAY

(76) Inventors: Chi-Feng LIN, Taipei (TW); Yu-Bin Fang, Taipei (TW); Yi-Fan Chen, Taipei (TW)

(21) Appl. No.: 12/620,263

(22) Filed: Nov. 17, 2009

(51) Int. Cl. G09G 3/36

(52) U.S. Cl. 345/102

(57) ABSTRACT

An optical sheet adapted to relevant backlight module and LCD includes a light guiding side, a light emitting side, and a plurality of microstructures disposed on the light emitting side. Each of the microstructures is formed in an aspheric contour. At an intersection of an X-line and Y-line of each microstructure cross-sectionally defines a first bottom joint, which extending toward opposing sides of the X-line to define two symmetrical second bottom joints and upwardly extending from the Y-line to construct a top point. A first arc route is formed between the top point and the second bottom joint, and a second straight route is formed between the top point and the second bottom joint. A third route is defined round a cross-sectional outside contour of each microstructure, which is located within an area surrounded by the first and the second routes.

### BACKGROUND OF THE INVENTION

1. Field of the Invention

The present invention relates to an optical sheet and relevant backlight module as well as liquid crystal display, in particular to an optical sheet including a light emitting side on which pluralities of aspheric microstructures are disposed and the same cooperating with the backlight module and the liquid crystal display.

2. Description of the Related Art

As a tendency, the liquid crystal display (LCD) has widely developed various electronic products, such as notebooks, LCD TVs, mobile phones, PDAs, etc. Generally, the LCD includes a backlight module and a liquid crystal panel; wherein, the backlight module is placed under the liquid crystal panel and essentially comprised of an optical sheet including a light source, a reflecting piece, a diffusing piece, brightness enhancement film, etc.

Referring to FIGS. 14 and 15, two conventional optical sheets A, B have respective light emitting surfaces A1, B1, on which a plurality of spherical microstructures A2 and conical microstructures B2 are disposed thereon, respectively. Besides, the microstructures configured into a uniform shape or formed by an assortment of shaped contours are commonly adopted, for instance formed by the aforementioned shapes, a rectangular shape, or a wave-rectangular shape. Additional description concerning the relevant techniques may also be found in U.S. Pat. No. 5917664 and 6825984, and Republic of China Patent No. M289203, M280484, M305348, M331676, M333584, 1274896, 1278662.

### SUMMARY OF THE INVENTION

The object of the present invention is to solve the conventional optical sheet for lacking of sufficient luminance and uniformity.

An optical sheet in accordance with the present invention includes a light guiding side and a light emitting side; wherein, a plurality of microstructures are disposed on the light emitting side, and each of the microstructures is formed into an aspheric configuration. Each microstructure cross sectionally intersects with the light emitting side at an X-line, which thence vertically meets at a Y-line. Further, the microstructure in cross section is in a symmetrical arrangement via centering the Y-line. The X-line and the Y-line intersect at a first bottom joint; the first bottom joint extends toward two sides of the X-line to symmetrically define two respective second bottom joints and then extends upwardly from the Y-line to form a top point. Moreover, a first arc route is defined between the top point and the second bottom joint, and a second straight route is formed between the top point and the second bottom joint; a third route is defined round an outside contour of the cross-sectional microstructure, whereby the third route is located within an area surrounded by the first and the second routes.

A backlight module in accordance with the present invention includes a light source, a reflecting plate, a first optical sheet, and a second optical sheet. Wherein, the light source serves to emit light, and the reflecting plate applies to reflect the light; further, the first optical sheet is disposed on the light source and the reflecting plate, which further includes a first light guiding side and a first light emitting side; wherein, a plurality of microstructures are disposed on the first light emitting side, and each of the microstructures is formed into an aspheric configuration. Each microstructure cross sectionally intersects with the first light emitting side at an X-line, which thence vertically meets at a Y-line. Further, the microstructure in cross section is in a symmetrical arrangement via centering the Y-line. The X-line and the Y-line intersect at a first bottom joint; the first bottom joint extends toward two sides of the X-line to symmetrically defined two respective second bottom joints and then extends upwardly from the Y-line to form a top point. Moreover, a first arc route is defined between the top point and the second bottom joint, and a second straight route is formed between the top point and the second bottom joint; a third route is defined round an outside contour of the cross-sectional microstructure, whereby the third route is located within an area surrounded by the first and the second routes. Additionally, the second optical sheet is disposed on the first optical sheet, which further has a second light guiding side and a second light emitting side; the second light emitting side thence has microstructures each in a pyramid thereon.

A liquid crystal display in accordance with the present invention includes a light source, a reflecting plate, a first optical sheet, a second optical sheet, and a liquid crystal panel. Wherein, the light source serves to emit light, and the reflecting plate applies to reflect the light; further, the first optical sheet is disposed on the light source and the reflecting plate, which further includes a first light guiding side and a first light emitting side; wherein, a plurality of microstructures are disposed on the first light emitting side, and each of the microstructures is formed into an aspheric configuration. Each microstructure cross sectionally intersects with the first light emitting side at an X-line, which thence vertically meets at a Y-line. Further, the microstructure in cross section is in a symmetrical arrangement via centering the Y-line. The X-line and the Y-line intersect at a first bottom joint; the first bottom joint extends toward two sides of the X-line to symmetrically defined two respective second bottom joints and then extends upwardly from the Y-line to form a top point. Moreover, a first arc route is defined between the top point and the second bottom joint, and a second straight route is formed between the top point and the second bottom joint; a third route is defined round an outside contour of the cross-sectional microstructure, whereby the third route is located within an area surrounded by the first and the second routes. Additionally, the second optical sheet is disposed on the first optical sheet, which further has a second light guiding side and a second light emitting side; the second light emitting side thence has microstructures each in a pyramid shape thereon. The liquid crystal panel is disposed on the second optical sheet for the purpose of displaying images.

The aforementioned third route defined on the optical sheet, backlight module, and liquid crystal display could be either shaped by an arc or by a connection of an arc and a straight line. Further, a center of the first route claimed in the optical sheet, backlight module, and liquid crystal display could be either located at the first bottom joint intersected by the X-line and Y-line or right below the first bottom joint on the Y-line.

Accordingly, the present invention has advantages as following described:

1. The present invention is beneficial of reducing the consumption of the optical sheets and increasing the luminance and the uniformity thereof, so as to correspondingly render the backlight module and the liquid crystal display thinner and lighter.
2. The microstructures of the present invention as described above are formed in an aspheric contour. The aspheric microstructures substantially change the light path and impinge on a diffusion of the light while emitting the light from the underside into the microstructures. Further, the second optical sheet, provided with the pyramid brightness enhancement structure, is disposed on the first optical sheet, which leads to a skew ray from the first optical sheet sending toward a positive direction for increasing the luminance of the backlight module.

### BRIEF DESCRIPTION OF THE DRAWINGS

FIG. 1 is a schematic view showing the present invention;

FIG. 1A is a partially enlarged view of the present invention;

FIG. 2 is a cross-sectional view showing the third route formed in an arc shape and a center of the first route set at the first bottom joint;

FIG. 3 is a cross-sectional view showing the third route formed by a connection of an arc and a straight line;

FIGS. 4A and 4B are cross-sectional views showing the center of the first route set right below the first bottom joint;

FIG. 5 is a schematic view showing the present optical sheet cooperating with a backlight module and a liquid crystal display;

FIGS. 6A to 6D illustrate rays of light entering the first optical sheet at different emitting angles;

FIG. 7 illustrates the cooperation of the second optical sheet and the first optical sheet possessing aspheric microstructures;

FIG. 8 is a schematic view showing the backlight module of the present invention in an experimental mode;

FIG. 9 shows an experiment result of the present invention;

FIG. 10 shows another experiment result of the present invention;

FIGS. 11A to 11G are charts showing variations of S_{fl} that perform the spatial luminance of aspheric microstructures cooperating with pyramid enhancement structures;

FIGS. 12A to 12F are charts showing variations of S_{fl} that perform the spatial luminance of spherical microstructures cooperating with pyramid enhancement structures;

FIGS. 13A to 13G are charts showing variations of S_{fl} that perform the spatial luminance of conical microstructures cooperating with pyramid enhancement structures;

FIG. 14 is a schematic view showing a conventional optical sheet provided with complete spherical microstructures; and

FIG. 15 is a schematic view showing a conventional optical sheet provided with conical microstructures.

### DETAILED DESCRIPTION OF THE PREFERRED EMBODIMENTS

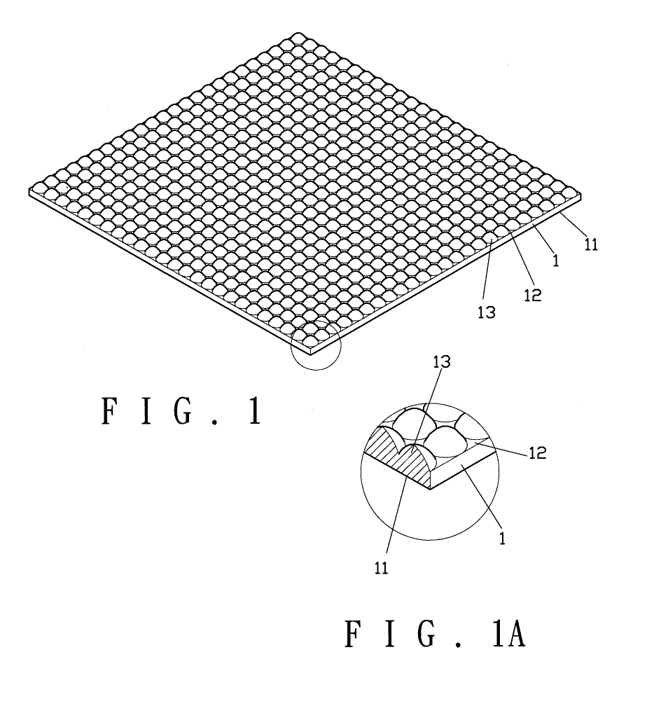

Referring to FIGS. 1, 2 and 3, an optical sheet 1 of the present invention includes a light guiding side 11 and a light emitting side 12; wherein, a plurality of microstructures 13 are disposed on the light emitting side 12, and the microstructures 13 are formed into an aspheric configuration. Each microstructure 13 cross sectionally intersects with the light emitting side 12 at an X-line, and the X-line vertically meets at a Y-line. Further, the microstructure 13 in cross section is put in a symmetrical arrangement via centering the Y-line. The X-line and the Y-line intersect at a first bottom joint 14; the first bottom joint 14 extends toward two sides of the X-line to symmetrically define two respective second bottom joints 15 and then extends upwardly from the Y-line to form a top point 16. Moreover, a first arc route 17 is defined between the top point 16 and the second bottom joint 15, and a second straight route 18 is defined from the top point 16 to the second bottom joint 15; a third route 19 is defined round an outside contour of the cross-sectional microstructure 13, whereby the third route 19 is located within an area surrounded by the first route 17 and the second route 18.

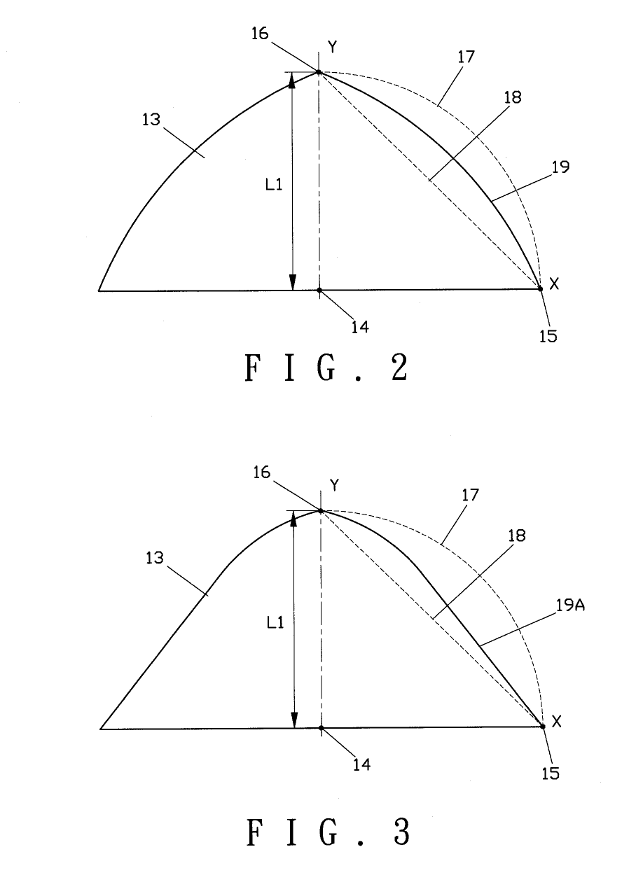

Referring to FIG. 2, a center of the first route 17 is located at the first bottom joint 14 intersected by the X-line and the Y-line, by which a distance L1 from the first bottom joint 14 to the top point 16 equals to the distance from the first bottom joint 14 to the second bottom joint 15, which renders the first route 17 as a quadrant.

Still referring to FIG. 2, the third route 19, located between the area surrounded by the first route 17 and the second route 18, is formed into an arcuate contour.

Referring to FIG. 3, the third route 19A, located between the area surrounded by the first route 17 and the second route 18, is shaped by a connection of an arc and a straight line.

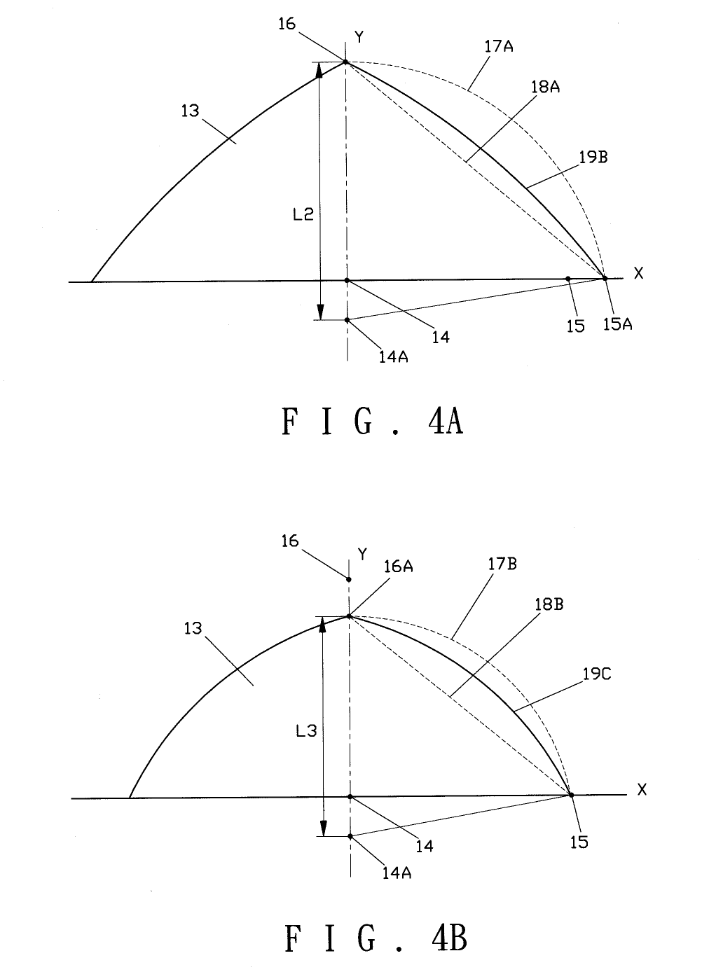

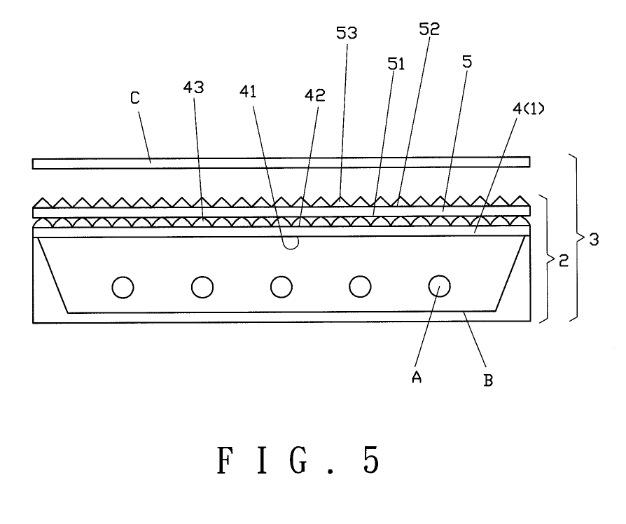

Referring to FIG. 4A distinguishing from FIG. 2, a center 14A of the first route 17A is placed right below the first bottom joint 14 on the Y-line, so as to define a radius whose length L2 goes from the center 14A to the top point 16. Further, the intersection of the first route 17A and the X-line is at a second bottom joint 15A escaping from the second bottom joint 15. As such, the distance between the center 14A and the second bottom joint 15A also equals to L2, which renders the first route 17A formed into an arcuate line. The second route 18A is formed by connecting the top point 16 and the second bottom joint 15A. Between the area surrounded by the first route 17A and the second route 18A, the third route 19B passes therethrough via an arc or a combination of an arc and a straight line.

Referring to FIG. 4B distinguishing from FIG. 2, the center 14A of the first route 17B is placed right below the first bottom joint 14, so as to define a radius whose length L3 goes from the center 14A to the second bottom joint 15. Further, the intersection of the first route 17B and the Y-line is at a top point 16A that is located inwardly from the top point 16 to the center 14A. As such, the distance between the center 14A and the top point 16A also equals to L3, which renders the first route 17B formed into an arcuate line. The second route 18B is formed by connecting the top point 16A and the second bottom joint 15. Between the area surrounded by the first route 17B and the second route 18B, the third route 19C passes therethrough via an arc or a combination of an arc and a straight line.

Consequently, while the third route 19, 19A in accordance with the present invention has shown and described to be located within the area surrounded by the first route 17 and the second route 18, it should be clear to those skilled in the art that the third route formed into an arc or configured by a connection of an arc and a straight line should be covered without departing from the scope of the present invention.

Referring to FIG. 5 shows the present optical sheet 1 cooperating with a backlight module 2 and a liquid crystal display 3. The backlight module 2 includes a light source A, a reflecting plate B, a first optical sheet 4, and a second optical sheet 5. Wherein, the light source A serves to emit light, and the reflecting plate B applies to reflect the light; further, the first optical sheet 4 is disposed on the reflecting plate B and the second optical sheet 5 is thence placed on the first optical sheet 4. Further, the first optical sheet 4, same to the configuration shown in FIG. 1, includes a first light guiding side 41 and a first light emitting side 42. A number of aspheric microstructures 43 are disposed on the first light emitting side 42. Additionally, the second optical sheet 5 has a second light guiding side 51 and a second light emitting side 52; the second light emitting side 52 has microstructures 53 each in a pyramid shape for serving as a brightness enhancement structure.

Continuing with the aforementioned, a liquid crystal panel C is disposed on the second optical sheet 5 for preferably displaying images, by which the integral liquid crystal display 3 is attained.

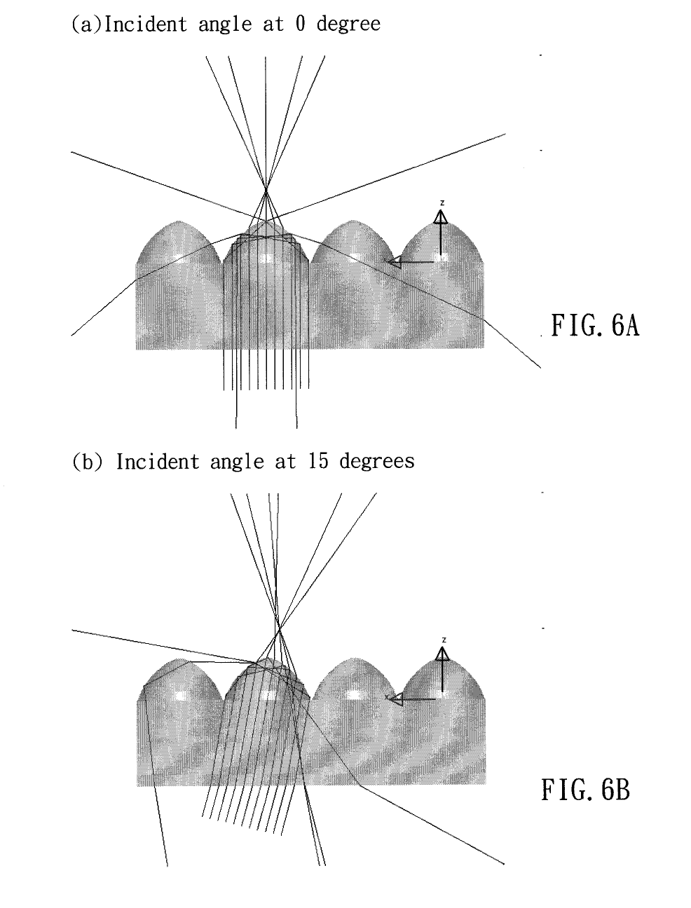

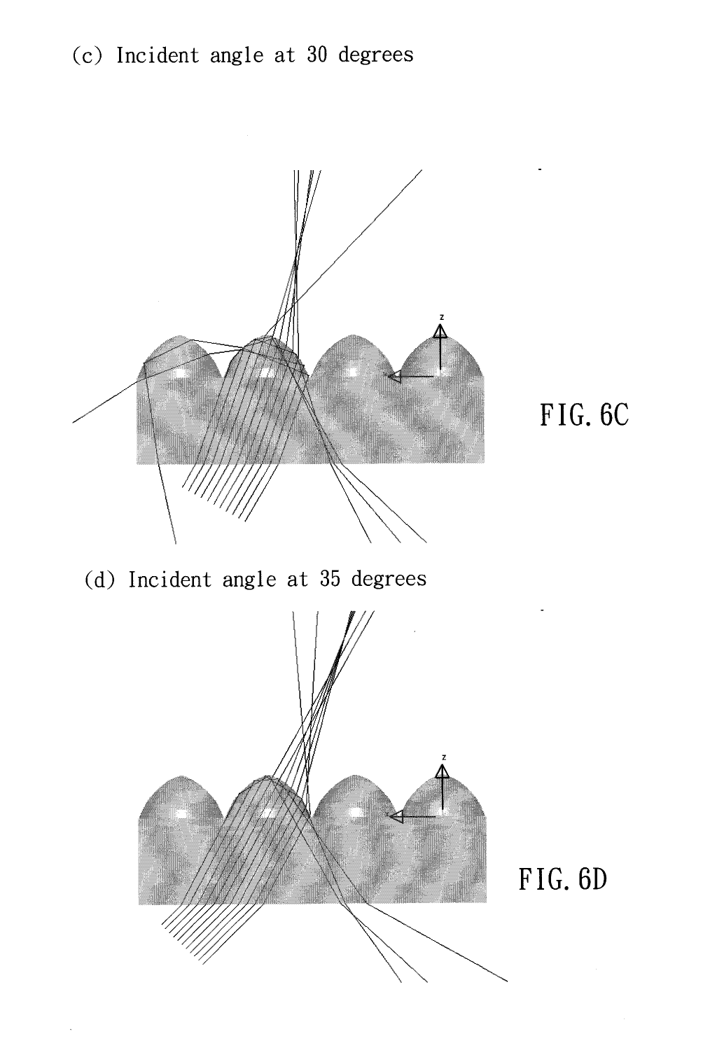

Moreover, FIGS. 6A to 6D illustrate rays of light entering the first optical sheet at different emitting angles, which are preferably diffused to a tolerance of ±35 degrees. The second optical sheet applies its pyramid brightness enhancement microstructures to lead the light forward ahead.

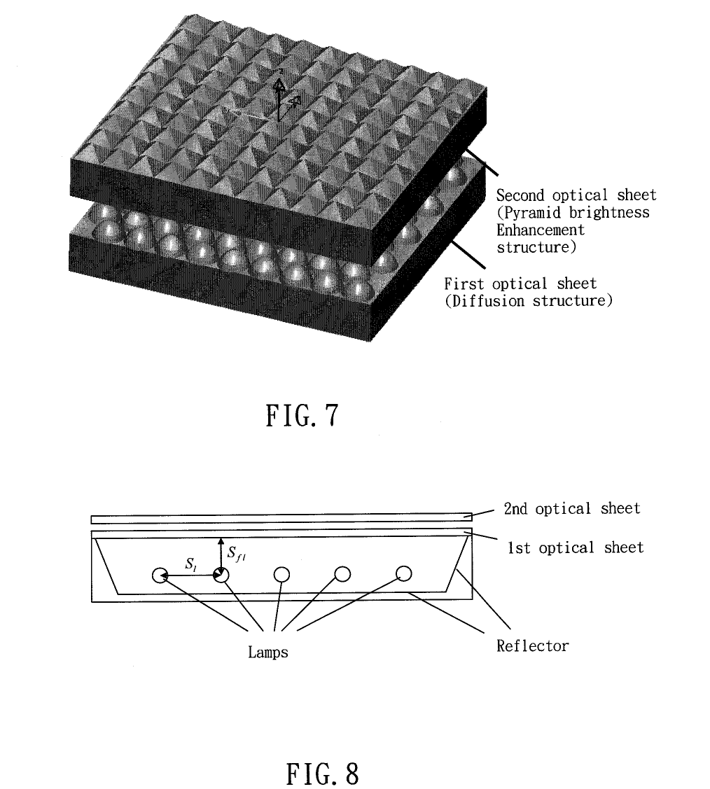

FIG. 7 illustrates the cooperation of the second optical sheet and first optical sheet possessing the aspheric microstructures for increasing the luminance of the backlight module.

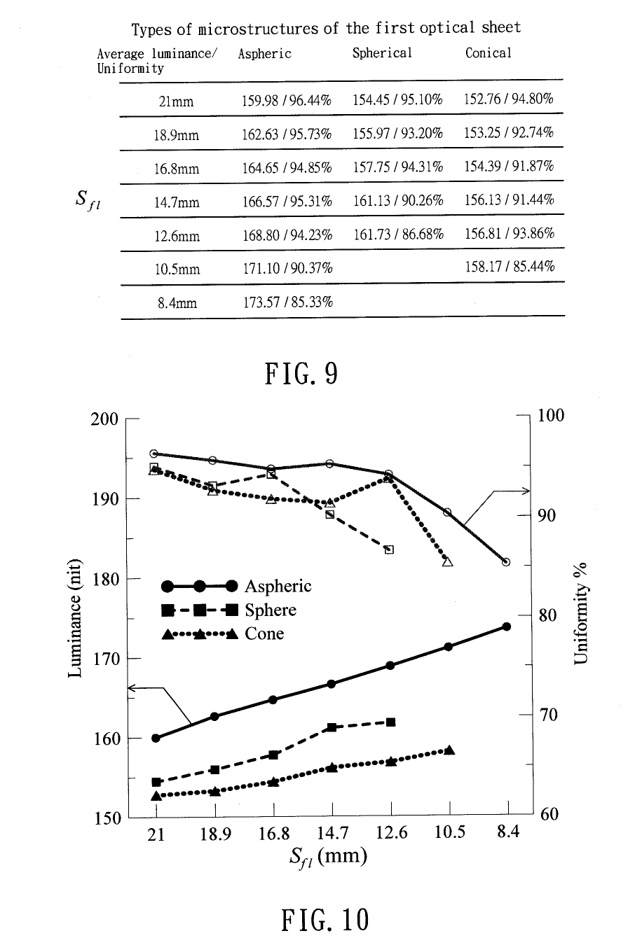

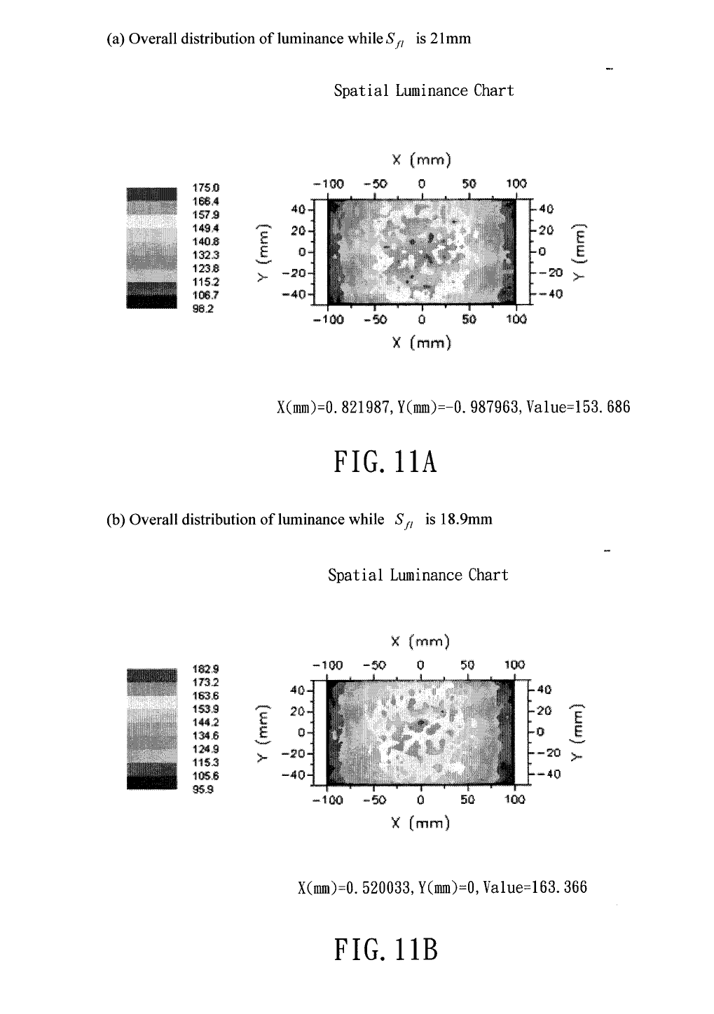

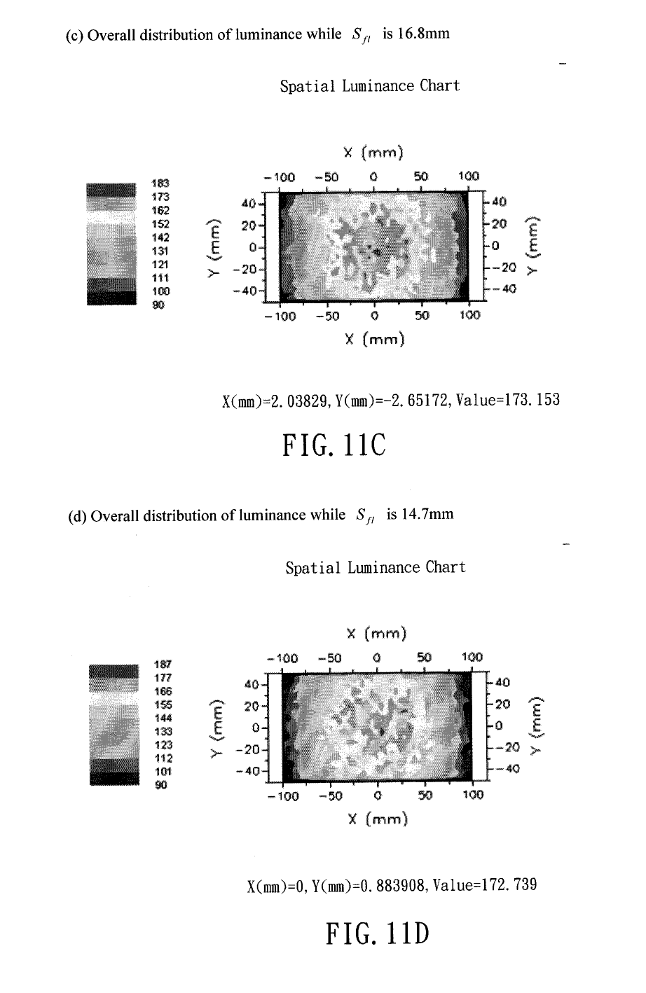

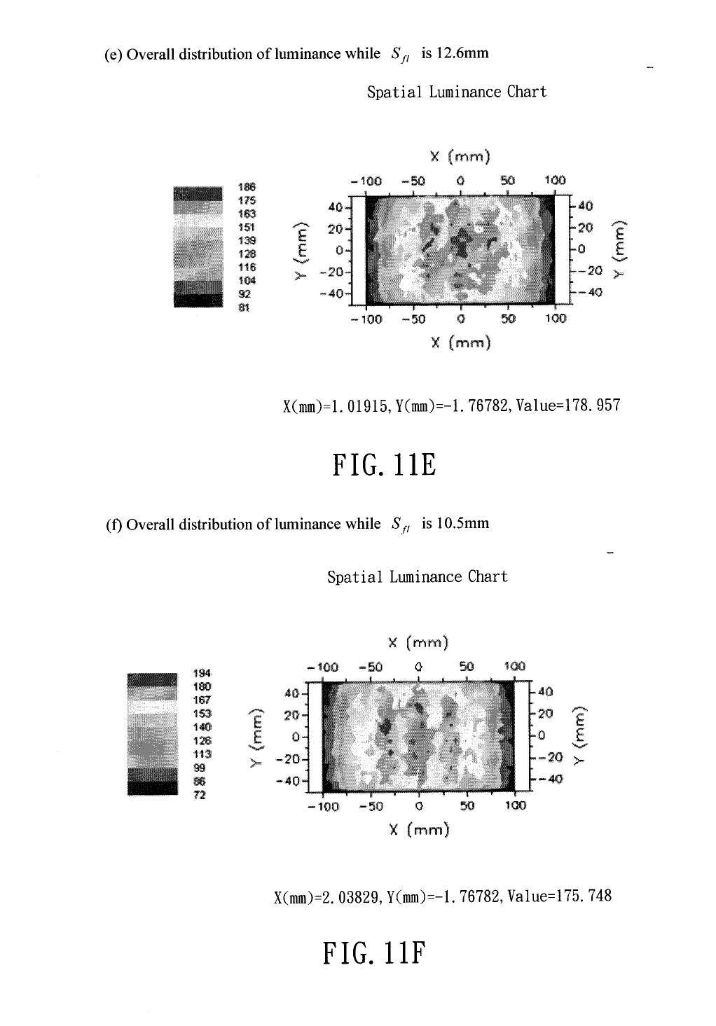

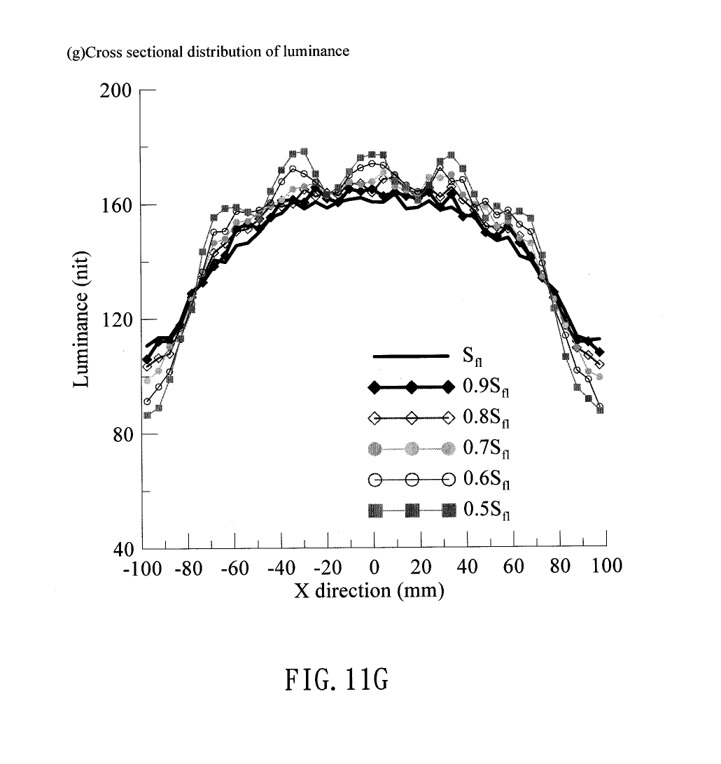

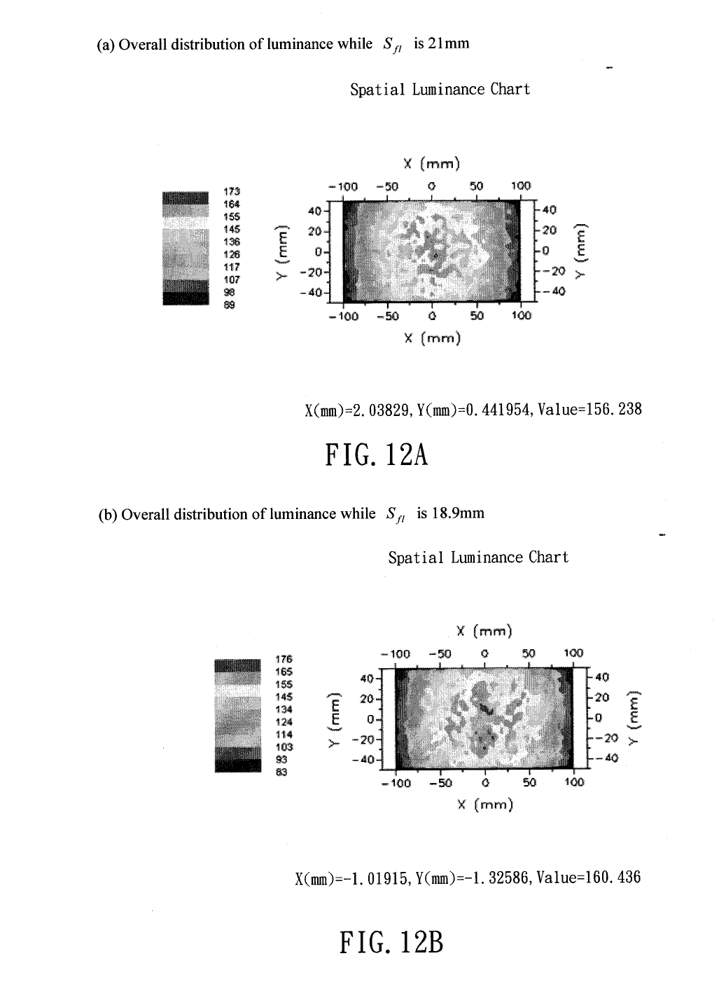

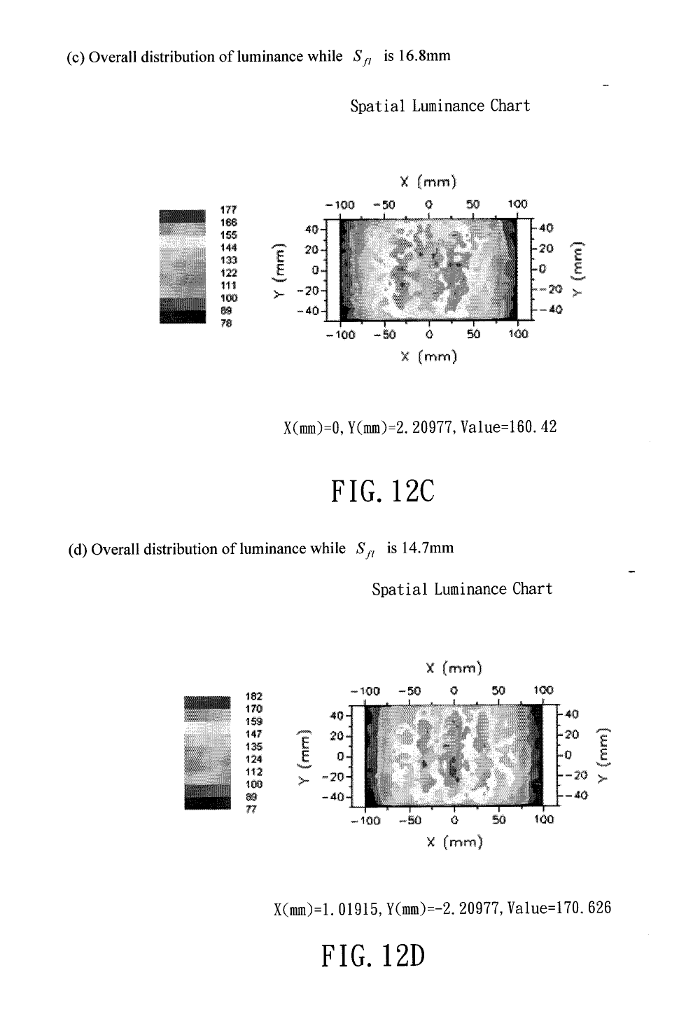

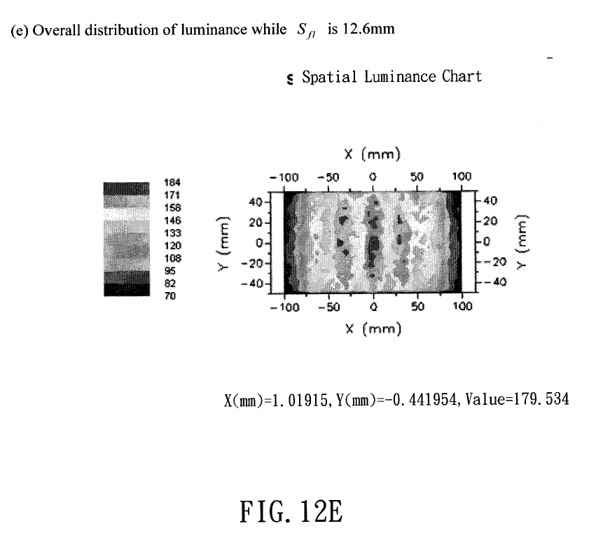

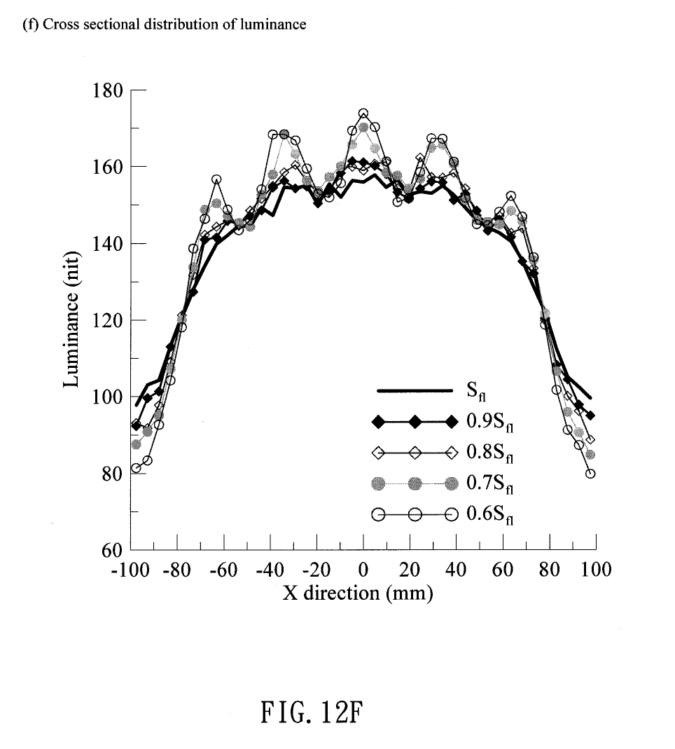

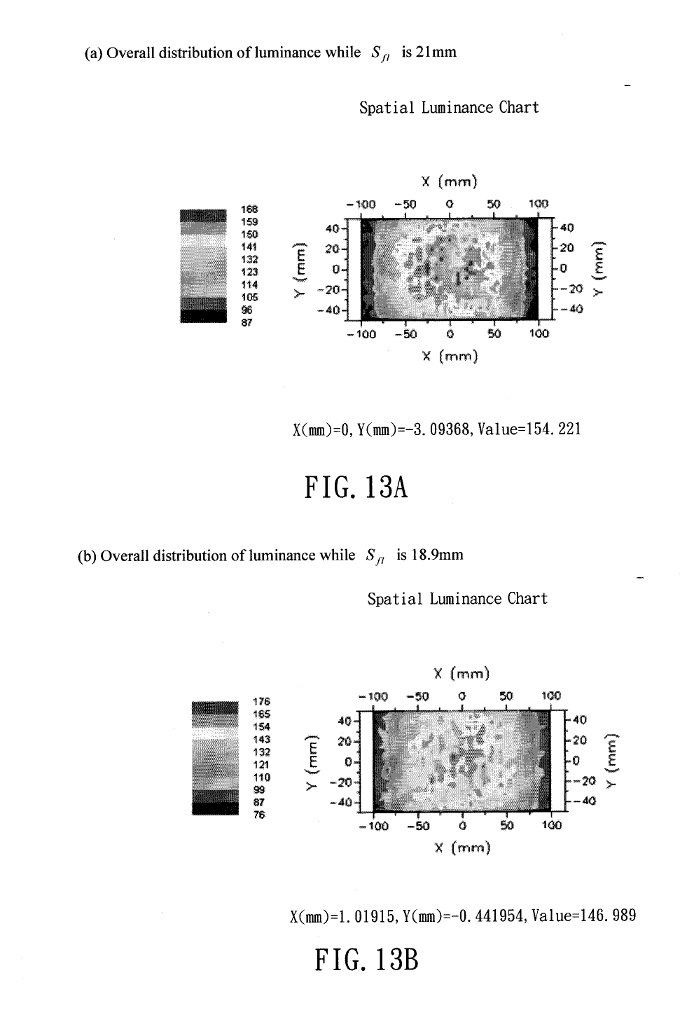

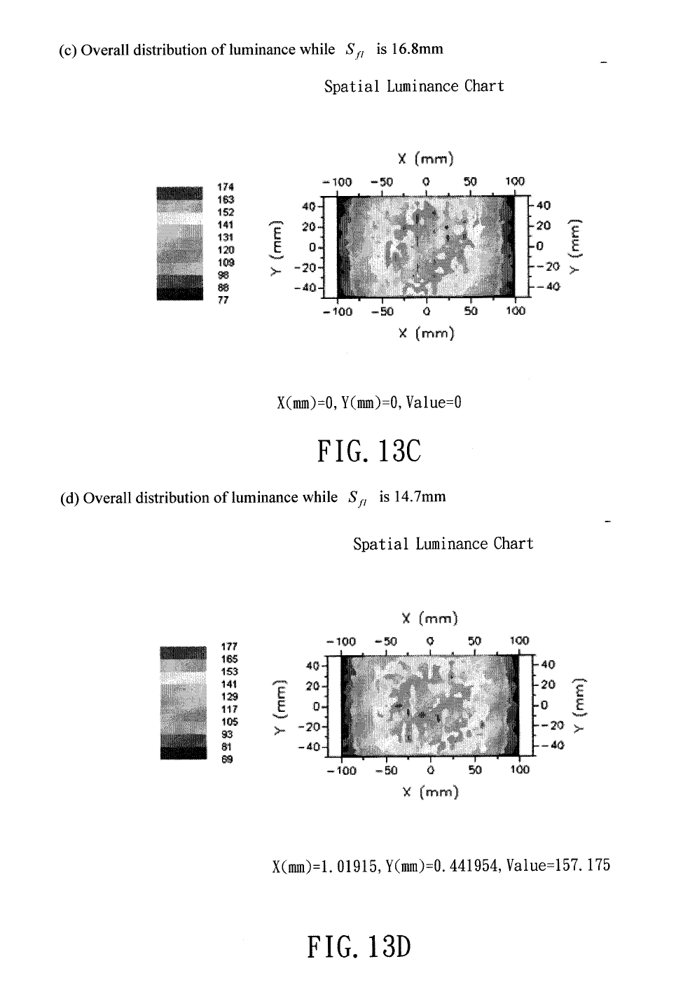

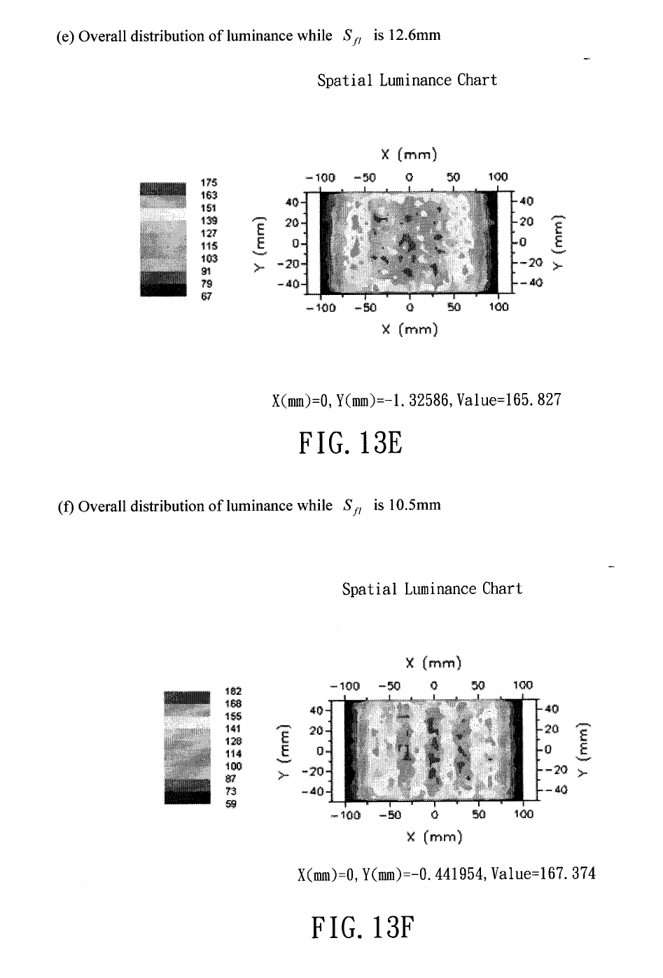

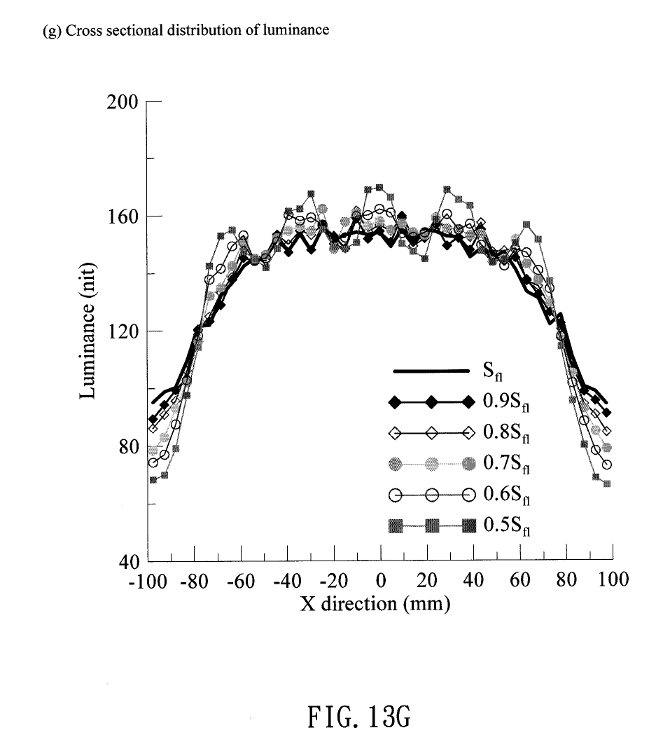

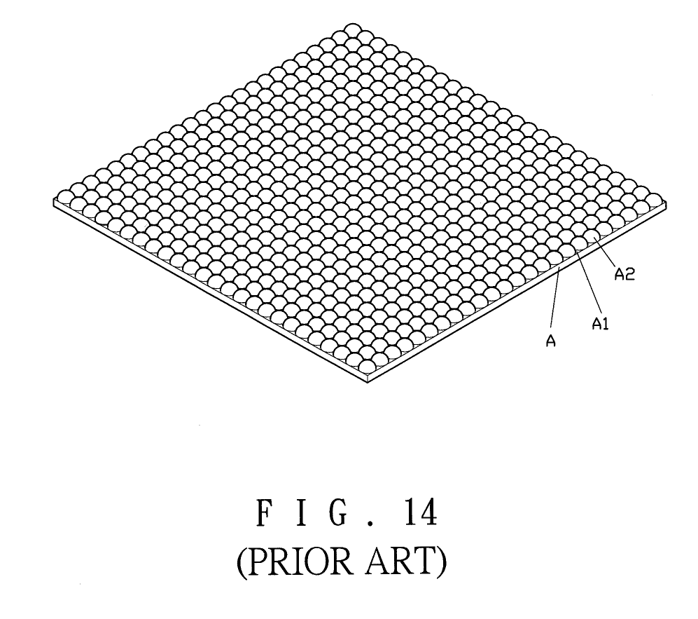

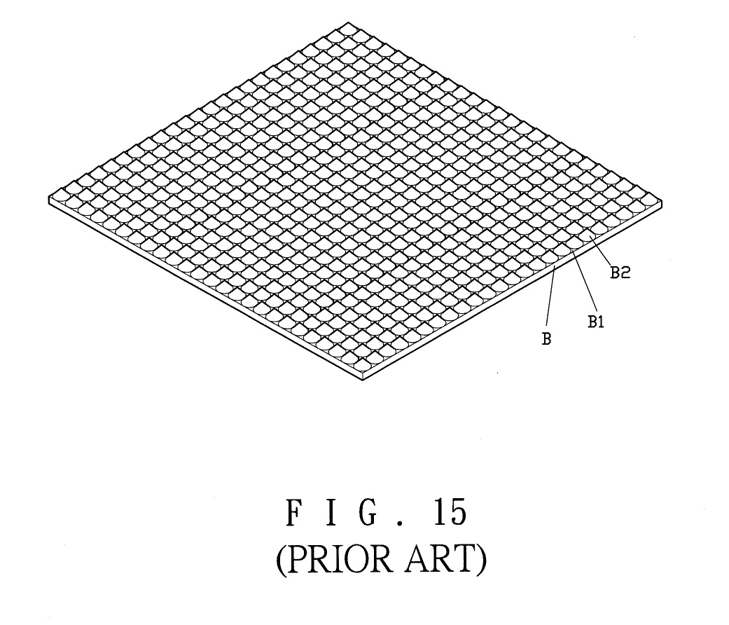

Comparisons between the present spatial luminance affected by the pyramid brightness enhancement structure respectively cooperating with the present aspheric, the typical spherical-contour, and conical microstructures are herein illustrated. The comparisons show the variations of the luminance of the backlight module under a gradual reduction of the distance S_{fl} between the first optical sheet and the light source. A basic experiment structure is shown in FIG. 8, in which the microstructures of the first optical sheet depend on shapes as variables like an aspheric contour, a spherical contour, and a cone configuration; wherein, the spherical height divided by the spherical width (or diameter) is 0.5, and the cone height divided by the cone width (or diameter) is 0.5. The second optical sheet is a pyramid brightness enhancement structure, and the top angle of which is set by 90 degrees. Based on the structure described above, FIGS. 9 to 13 respectively illustrate the experiment results. In terms of the uniformity, the aspheric microstructures get a great uniformity under the condition of S_{fl} ranged over 12.6 mm, the spherical microstructures maintains its high uniformity under the condition of S_{fl} ranged over 16.8 mm, and the conical microstructures keeps its high uniformity under the condition of S_{fl} ranged over 12.6 mm. Under a tendency toward a thinner backlight module, i.e. reducing the value of S_{fl}, the results above could substantially conclude that the spherical microstructures can not maintain a high uniformity in case of decreasing the S_{fl} value, whereas the aspheric and conical microstructures could still keep the same a high level of uniformity. In terms of the average luminance, the average luminance of the aspheric microstructures is 1.036 times higher than that of the spherical microstructures and is 1.047 times higher than that of the conical microstructures. In the condition of setting S_{fl} at 12.6 mm, the average luminance of the aspheric microstructures is 1.063 times higher than that of the conical microstructures. Consequently, the optical sheet with aspheric microstructures could efficiently increase the luminance. It is also noted that such optical sheet could not only maintain high uniformity but attain the brightness enhancement while reducing the S_{fl} value.

I claim:

1. An optical sheet, comprising a light guiding side and a light emitting side, said light emitting side including a plurality of microstructures disposed thereon, said microstructures each being formed into an aspheric configuration; each of said microstructures in cross section intersecting with said light emitting side at an X-line, and said X-line vertically meeting at a Y-line; said microstructure in cross section being in a symmetrical arrangement via centering said Y-line; said X-line and said Y-line meeting at a first bottom joint; said first bottom joint extending toward two sides of said X-line to symmetrically defined two respective second bottom joints and extending upwardly from said Y-line to form a top point; a first route as an arc contour being defined between said top point and said second bottom joint, and a second route as a straight line being formed between said top point and said second bottom joint; a third route being defined round an outside contour of said microstructure in cross section; said third route being located within an area surrounded by said first and said second routes.

2. The optical sheet as claimed in claim 1, wherein said third route is shaped by an arc.

3. The optical sheet as claimed in claim 1, wherein said third route is shaped by a connection of an arc and a straight line.

4. The optical sheet as claimed in claim 1, wherein said first bottom joint serves as a center of said first route.

5. The optical sheet as claimed in claim 1, wherein a center of said first route is located right below said first bottom joint.

6. The optical sheet as claimed in claim 5, wherein a radius of said first route equals to a distance from said center to said top point.

7. The optical sheet as claimed in claim 5, wherein a radius of said first route equals to a distance from said center to said second bottom joint.

8. A backlight module, comprising:
a light source for emitting light;
a reflecting plate for reflecting light;
a first optical sheet disposed on said light source and said reflecting plate; said first optical sheet comprising a first light guiding side and a first light emitting side; said first light emitting side including a plurality of microstructures disposed thereon, said microstructures each being formed into an aspheric configuration; each of said microstructures in cross section intersecting with said first light emitting side at an X-line, and said X-line vertically meeting at a Y-line; said microstructure in cross section being in a symmetrical arrangement via centering said Y-line; said X-line and said Y-line meeting at a first bottom joint; said first bottom joint extending toward two sides of said X-line to symmetrically defined two respective second bottom joints and extending upwardly from said Y-line to form a top point; a first route as an arc contour being defined between said top point and said second bottom joint, and a second route as a straight line being formed between said top point and said second bottom joint; a third route being defined round an outside contour of said microstructure in cross section; said third route being located within an area surrounded by said first and said second routes; and
a second optical sheet disposed on said first optical sheet, said second optical sheet comprising a second light guiding side and a second light emitting side, said second light emitting side having microstructures each in a pyramid shape thereon.

9. The backlight module as claimed in claim 8, wherein said third route is shaped by an arc.

10. The backlight module as claimed in claim 8, wherein said third route is shaped by a connection of an arc and a straight line.

11. The backlight module as claimed in claim 8, wherein said first bottom joint serves as a center of said first route.

12. The backlight module as claimed in claim 8, wherein a center of said first route is located right below said first bottom joint.

13. The backlight module as claimed in claim 12, wherein a radius of said first route equals to a distance from said center to said top point.

14. The backlight module as claimed in claim 12, wherein a radius of said first route equals to a distance from said center to said second bottom joint.

15. A liquid crystal display, comprising:
a light source for emitting light;
a reflecting plate for reflecting light;
a first optical sheet disposed on said light source and said reflecting plate; said first optical sheet comprising a first light guiding side and a first light emitting side; said first light emitting side including a plurality of microstructures disposed thereon, and said microstructures each being formed into an aspheric configuration; each of said microstructures in cross section intersecting with said first light emitting side at an X-line, and said X-line vertically meeting at a Y-line; said microstructure in cross section being in a symmetrical arrangement via centering said Y-line; said X-line and said Y-line meeting at a first bottom joint; said first bottom joint extending toward two sides of said X-line to symmetrically defined two respective second bottom joints and extending upwardly from said Y-line to form a top point; a first route as an arc contour being defined between said top point and said second bottom joint, and a second route as a straight line being formed between said top point and said second bottom joint; a third route being defined round an outside contour of said microstructure in cross section; said third route being located within an area surrounded by said first and said second routes;
a second optical sheet disposed on said first optical sheet, said second optical sheet comprising a second light guiding side and a second light emitting side; said second light emitting side having microstructures each in a pyramid shape thereon; and
a liquid crystal panel disposed on said second optical sheet for displaying images.

16. The liquid crystal display as claimed in claim 15, wherein said third route is shaped by an arc.

17. The liquid crystal display as claimed in claim 15, wherein said third route is shaped by a connection of an arc and a straight line.

18. The liquid crystal display as claimed in claim 15, wherein said first bottom joint serves as a center of said first route.

19. The liquid crystal display as claimed in claim 15, wherein a center of said first route is located right below said first bottom joint.

20. The liquid crystal display as claimed in claim 19, wherein a radius of said first route equals to a distance from said center to said top point.

21. The liquid crystal display as claimed in claim 19, wherein a radius of said first route equals to a distance from said center to said second bottom joint.
